(19) United States
(12) Patent Application Publication
(10) Pub. No.: US 2013/0305331 A1
(43) Pub. Date: Nov. 14, 2013

(54) AUTHENTICATION AND MANAGEMENT SERVICE SYSTEM FOR PROVIDING LOCATION INFORMATION AND METHOD FOR PROVIDING THE SAME

(71) Applicant: Seong Soo Kim, Seoul (KR)

(72) Inventor: Seong Soo Kim, Seoul (KR)

(21) Appl. No.: 13/991,820

(22) PCT Filed: Nov. 2, 2010
(86) PCT No.: PCT/KR2010/007631

§ 371 Date: Jun. 5, 2013

(51) Int. Cl. H04W 12/06

(52) U.S. Cl. CPC H04W 12/06
USPC 726/6

(57) ABSTRACT

The present invention relates to an authentication and management service system for providing location information wherein in providing location information on an individual through a mobile network by using a certificate for location information sharing, the certificate for location information sharing is issued previously to a wireless terminal (mobile phone) of a designated person (parent) of a location information sharing object (child), the location information of the location information sharing object is requested and received from a mobile communication system, and the certificate for location information sharing is selectively provided and managed to other designated person and organization.

### BACKGROUND OF THE INVENTION

1. Field of the Invention

The present invention relates to an authentication and management service system for providing location information wherein in providing location information on an individual through a mobile network by using a certificate for location information sharing, the certificate for location information sharing is issued previously to a wireless terminal (mobile phone) of a designated person (parent) of a location information sharing object (child), the location information of the location information sharing object is requested and received from a mobile communication system, and the certificate for location information sharing is selectively provided and managed to other designated person and organization.

2. Background of the Related Art

A mobile communication system provides current location information of a user of a terminal through the location information of the terminal, and further provides a variety of services using the location information-based technologies.

The location information service of an individual using the mobile communication system is very limitedly managed because the location information sharing of the individual causes his or her private life to be invaded, unless emergency rescue system like national emergency management agency requests the location information of an individual under the request of the individual in a dangerous situation or his or her spouse to a mobile communication company (location information provider) without having any agreement of the location information sharing object.

Before the location information sharing of the individual requested is approved, however, relatively lots of time is first needed for the identity check of the location information sharing requester (inclusive of organization), so that it is impossible to provide rapid handling to the location information sharing object in a dangerous situation.

Even if the assistance of the police is urgently needed in daily life, further, the location information of the location information sharing object cannot be rapidly provided to the police, thereby making it hard to help the object at crime scenes or in a dangerous situation.

### SUMMARY OF THE INVENTION

Accordingly, the present invention has been made in view of the above-mentioned problems occurring in the prior art, and it is an object of the present invention to provide an authentication and management service system for providing location information wherein a certificate for location information sharing is issued previously to a wireless terminal (mobile phone) of a designated person (parent) of a location information sharing object (child), the location information of the location information sharing object is requested and received from a mobile communication system, and the certificate for location information sharing is copied and sent to other person and organization selectively designated under the need of the original issuer of the certificate so that the location information of the location information sharing object is provided rapidly to other person and organization, without having any identity check (inclusive of the relationship with the location information sharing object), thereby quickly checking the current location of the object and rapidly taking a care of the object.

To accomplish the above object, according to a first aspect of the present invention, there is provided an authentication and management service system for providing location information, the system including: an authentication service system for issuing a certificate for location information sharing of a location information sharing object to a designated person of the location information sharing object and for checking the information of the certificate issued and managed in response to the request of the authentication of the certificate for location information sharing from a mobile communication system to authenticate the location information sharing of the mobile communication system; the mobile communication system for providing a location information service in accordance with the authentication results of the authentication service system of the certificate for location information sharing received upon request of the location information sharing from a wireless terminal where the certificate for location information sharing is saved; a first wireless terminal for requesting the issuance of the certificate for location information sharing of the location information sharing object to the authentication service system, and saving and managing the issued certificate, and registered in the authentication service system as the certificate issuance designated person to request the location information sharing in communication with the mobile communication system; and a second wireless terminal as the location information sharing object.

According to the present invention, preferably, the authentication service system further comprises means for providing a management process of the certificate for location information sharing wherein the certificate for location information sharing is copied and sent to a third wireless terminal of another person (guardian or contact person) designated from the first wireless terminal of the designated person to which the certificate for location information sharing is issued or sent to a fourth wireless terminal of an aid organization (the police).

According to the present invention, preferably, the authentication service system is included in the mobile communication system to allow a mobile communication company to provide the certificate service.

To accomplish the above object, according to a first aspect of the present invention, there is provided an authentication and management service system for providing location information, the system including: a mobile communication system having a location information sharing authentication server for issuing a certificate for location information sharing of a location information sharing object to a designated person registered in the subscriber information of the location information sharing object and for checking the certificate information issued and managed for the certificate for location information sharing received upon request of the location information sharing to determine and provide the location information sharing of the location information sharing object; a first wireless terminal for requesting the issuance of the certificate for location information sharing of the location information sharing object to the mobile communication system, and saving and managing the issued certificate, and registered in the subscriber information in the mobile communication system as the certificate issuance designated person to request the location information sharing in communication with the mobile communication system; and a second wireless terminal as the location information sharing object.

According to the present invention, preferably, the location information sharing authentication server of the mobile communication system further comprises means for providing a management process of the certificate for location information sharing wherein the certificate for location information sharing is copied and sent to a third wireless terminal of another person (guardian or contact person) designated from the first wireless terminal of the designated person to which the certificate for location information sharing is issued or sent to a fourth wireless terminal of an aid organization (the police).

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view showing an authentication and management service system for providing location information according to the present invention;

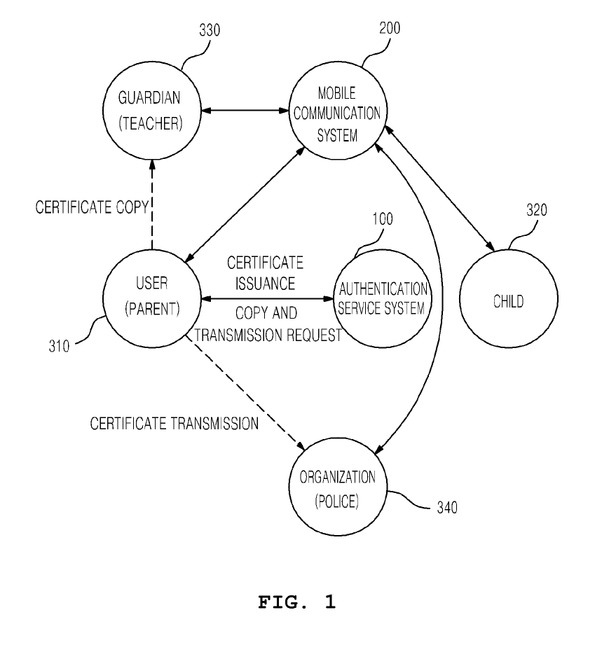

FIG. 2 is a block diagram showing the authentication and management service system for providing location information according to the present invention;

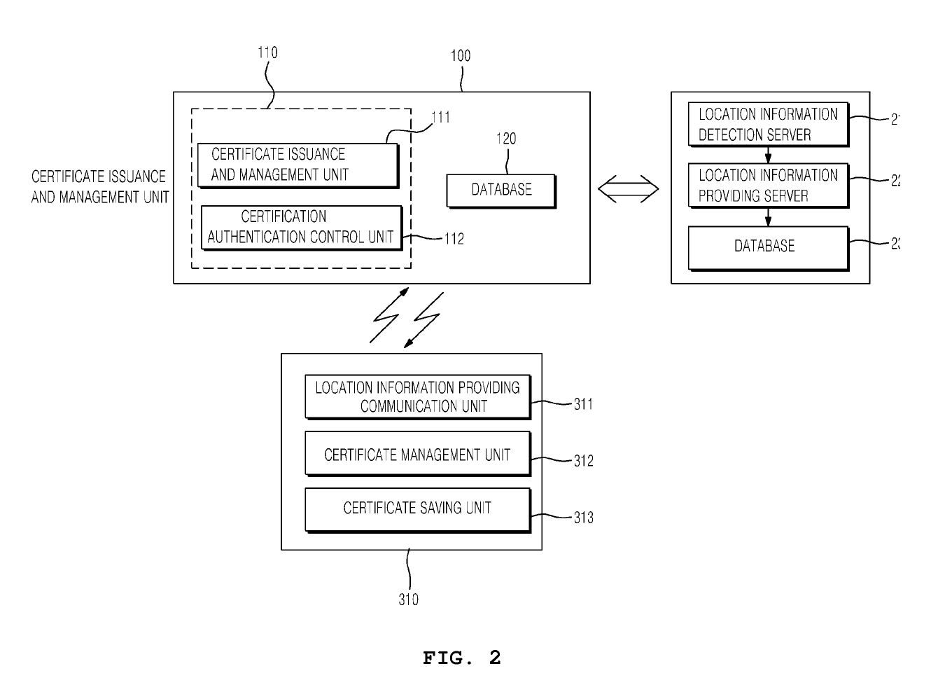

FIG. 3 is a flow chart showing a certification issuing procedure conducted in an authentication service system in the system according to the present invention;

FIG. 4 is a flow chart showing the position information providing procedure conducted in a mobile communication system; and

FIG. 5 is a flow chart showing an authentication procedure for the certificate for the location information sharing conducted in the authentication service system in the system according to the present invention.

### DETAILED DESCRIPTION OF THE PREFERRED EMBODIMENT

Hereinafter, an explanation on an authentication and management service system for providing location information according to the present invention will be in detail given with reference to the attached drawing.

According to the present invention, an authentication and management service system for providing location information includes: an authentication service system 100 for issuing a certificate for location information sharing of a location information sharing object to a designated person of the location information sharing object and for checking the information of the certificate issued in response to the request of the authentication of the certificate for location information sharing from a mobile communication system 200 to authenticate the location information sharing of the mobile communication system 200; the mobile communication system 200 for providing a location information service in accordance with the authentication results of the authentication service system 100 of the certificate for location information sharing received upon request of the location information sharing of an individual from a user; a first wireless terminal 310 for requesting the issuance of the certificate for location information sharing of a second wireless terminal 320 of a location information sharing object to the authentication service system 100, and saving and managing the issued certificate, and serving as a designated person for requesting the location information sharing in communication with the mobile communication system 200; the second wireless terminal 320 as the location information sharing object; a third wireless terminal 330 of a guardian for copying and saving the certificate for location information sharing from the first wireless terminal 310 and designated from the designated person to request the location information sharing in communication with the mobile communication system 200; and a fourth wireless terminal 340 of aid organizations (the police) for receiving the certificate for location information sharing from the first wireless terminal 310 to request the location information sharing of the second wireless terminal 320.

The authentication service system 100 includes: an authentication management server 110 for issuing and managing the certificate for location information sharing and authenticating the certificate for location information sharing in communication with the first wireless terminal 310 and the mobile communication system 200; and a database 120 for saving and managing the issuance detail information of the certificate for location information sharing, the information of the issued certificate for location information sharing, authentication detail information and set membership information.

The authentication management server 110 includes: a certificate issuance and management unit 111 for checking subscriber information through the mobile communication system 200 in response to the request of the issuance for the certificate for location information sharing from the first wireless terminal 310, issuing the certificate for location information sharing using the checked subscriber information, and managing the issued certificate for location information sharing; and a certificate authentication control unit 112 for comparing the certificate for location information sharing of which authentication is requested from the mobile communication system 200 with the issued certificate for location information sharing saved and managed in the database 120 to provide authentication check information to the mobile communication system 200.

The mobile communication system 200 includes: a location information detection server 210 for detecting the location of the second wireless terminal 320 of the location information sharing object and producing the location information to be provided to the first wireless terminal 310, the third wireless terminal 330 or the fourth wireless terminal 340, using the detected location; a location information providing server 220 for requesting the authentication service system 100 to authenticate the certificate for location information sharing transmitted upon the request of the location information sharing from the wireless terminal and providing the location information produced from the location information detection server 210 in accordance with the authentication result to the wireless terminal requesting the location information sharing; and a database 230 for saving and managing the mobile communication subscriber information, the location information request detail information, and the provided location information.

The first wireless terminal 310 includes: a location information providing communication unit 311 for providing current terminal location information to the mobile communication system 200; a certificate management unit 312 for requesting the certificate for location information sharing through the connection to the authentication service system 100 and for saving and managing the certificate issued from the authentication service system 100; and a certificate saving unit 313 for saving the certificate.

According to the present invention, the certificate for location information sharing is previously registered in the first wireless terminal 310 of the designated person (parent), so that the parent receives the location information using the certificate for location information sharing and further allows the certificate for location information sharing to be copied or sent to the third wireless terminal 330 of the guardian or contact person (in case of adults) or to the fourth wireless terminal 340 of the aid organization (the police), thereby requesting the mobile communication system 200 to provide the location information.

According to the present invention, therefore, the system largely includes the authentication service system 100, the mobile communication system 200 and the wireless terminal 300 of the user for using the certificate for location information sharing.

The authentication service system 100 serves to issue the certificate for location information sharing and to provide the authentication result of the certificate for location information sharing to a mobile communication company, and in this case, the mobile communication company itself can build the authentication service system 100.

The authentication service system 100 is the service system that serves to issue the certificate for location information sharing and to check the information on the certificate issued in response to the request of the location information sharing from the mobile communication company to authenticate the location information sharing of the mobile communication company.

The certification management server 110 of the authentication service system 100 is means for providing the processes of issuing the certificate for location information sharing in communication with the first wireless terminal 310 and the mobile communication system 200 and conducting the authentication of the certificate for location information sharing requested from the mobile communication system 200.

The database 120 is means for saving and managing the issuance detail information of the certificate for location information sharing, the information of the certificate for location information sharing, authentication detail information and set membership information.

The issuance detail information of the certificate includes the history information of the certificate issued until now.

The information of the certificate for location information sharing includes basic information of the certificate and additional information on the copy and transmission of the certificate.

The base information includes inherent identification information, certificate issuer, validation period, issuer, and the information on the wireless terminal of the location information sharing object.

The additional information includes the certificate attribute information indicating whether copy is possible or not and validation period information.

The authentication detail information includes the detail information of which authentication is requested from the mobile communication system 200.

The set membership information includes the set information on the relationship with the person whose location information is to be shared, that is, includes the information on the designated person to which the certificate for location information sharing of the location information sharing object is issued.

For example, if a child becomes the location information sharing object, the designated person to which the certificate for location information sharing of the location information sharing object is issued is the child's parents.

The certification management server 110 checks whether the issuance requester is registered or not as the designated person in the relationship of the location information sharing object, through the set membership information, and conducts the issuing process of the certificate in accordance with the checked result.

The certification management server 110 includes the certificate issuance and management unit 111 for issuing and managing the certificate for location information sharing and the certificate authentication control unit 112 for authenticating the certificate for location information sharing of which authentication is requested.

The certificate issuance and management unit 111 checks subscriber information through the mobile communication system 200 in response to the request of the issuance of the certificate for location information sharing from the first wireless terminal 310 and issues the certificate for location information sharing using the checked subscriber information.

Further, the certificate issuance and management unit 111 conducts the certificate information change request process wherein the issued certificate for location information sharing is copied from the first wireless terminal 310 to the third wireless terminal 330 or transmitted or copied to the fourth wireless terminal 340 and the copied and transmitted certificate is deleted and conducts the certificate management process wherein the copy and transmission details are managed.

Further, the certificate issuance and management unit 111 includes information attaching means for attaching the location information provided from the mobile communication system transmitted together with the request of the transmission of the certificate from the first wireless terminal 310 to the certificate for location information sharing, thereby sending the attached location information to the set aid organization (the police).

The certificate authentication control unit 112 compares the certificate for location information sharing of which authentication is requested from the mobile communication system 200 with the issuance information on the issued certificate for location information sharing saved and managed in the database 120 to provide the authentication check information to the mobile communication system 200.

The certificate authentication control unit 112 further includes notification means for determining whether the certificate for location information sharing of which authentication is requested from the mobile communication system 200 is the certificate for location information sharing of an original issuer or copied or transmitted, and if it is copied or transmitted, for transmitting the detail information on the request of the certificate for location information sharing to the first wireless terminal 310 of the original issuer.

The mobile communication system 200 is a service system providing the mobile communication service to the user of the wireless terminal 300.

The mobile communication system 200 includes the location information detection server 210, the location information providing server 220 and the database 230.

The location information detection server 210 detects the location information of the wireless terminal 300 of the location information sharing object through the communication with the wireless terminal 300 and produces the location information using the detected location information.

The location information detection server 210 further includes location information producing means using geographic information, the location information producing means having a GIS (Geographic information system) information database to convert the detected location information of the second wireless terminal 320 into the GIS information, thereby producing the location information of the second wireless terminal 320.

The location information providing server 220 requests the authentication service system 100 to authenticate the certificate for location information sharing transmitted upon the request of the location information sharing from the wireless terminal 300 and provides the location information produced from the location information detection server 210 in accordance with the authentication result to the wireless terminal requesting the location information sharing.

The database 230 saves and manages the mobile communication subscriber information, the location information request detail information, and the detected and provided location information.

The location information request detail information includes a location information sharing requester, and the information on the wireless terminal (telephone numbers or subscriber name) of the location information sharing object.

The first wireless terminal 310 is mobile communication terminal means.

The location information providing communication unit 311 is communication means like a GPS module for providing current terminal location information to the mobile communication system 200.

According to the present invention, for the convenience of the description, the wireless terminal is divided into the first to fourth terminals, but the first to fourth terminals may have the same configuration as each other.

An example of the location information providing communication unit 311 is the GPS module, but the location information detection of the mobile phone is conducted using general technologies like cellular system.

The certificate management unit 312 requests the certificate for location information sharing through the connection to the authentication service system 100 and saves and manages the certificate issued from the authentication service system 100.

The certificate management unit 312 conducts the issuance request of the certificate, the copy and transmission request of the issued certificate, and the location information sharing request in accordance with the downloading to the wireless terminal 300 through a separate program or the process provided from the authentication service system 100 in wireless communication environments.

The certificate saving unit 313 is memory means where the issued certificate for location information sharing is saved.

Under the above-mentioned configuration, the service for issuing, authenticating and managing the certificate for the location information sharing is conducted through the following procedure.

On the other hand, the authentication service system 100 conducting the certificate issuance and management includes the steps of: a certificate object information checking process wherein if the issuance of the certificate for location information sharing is requested from the first wireless terminal 310, the set membership information is checked and the issuance request information inputted from the first wireless terminal 310 is transmitted to the mobile communication system 200 to request the subscriber checking; a certificate issuance process wherein the subscription checking information on the subscriber information from the mobile communication system 200 is received, and if the subscriber is a normal subscriber, the issuance of the certificate is determined to transmit the certificate for location information sharing to the wireless terminal requesting the issuance of the certificate for location information sharing; and a certificate management process wherein the certificate for location information sharing is copied and sent to the third wireless terminal 330 of the guardian or contact person and sent to the fourth wireless terminal 340 of the aid organization (the police) in accordance with the management information inputted upon the request of the first wireless terminal 310 where the certificate for location information sharing is saved and the deletion of the copied and sent certificate and the set change of the validation period are conducted.

The certificate issuance process includes the steps of: a certificate issuance request process where the issuance of the certificate for location information sharing is requested from the first wireless terminal 310 through the connection to the authentication service system 100; a certificate object information check process where the set membership information of the second wireless terminal 320 of the location information sharing object requested from the first wireless terminal 310 is checked to determine whether the checked result is registered as the designated person of the certificate for location information sharing requested from the first wireless terminal 310 and the subscription information on the first wireless terminal 310 and the second wireless terminal 320 is requested to the mobile communication system 200; a subscriber check process wherein the subscription information on the first wireless terminal 310 and the second wireless terminal 320 requested from the authentication service system 100 is checked and transmitted to the authentication service system 100; a certificate issuance process wherein it is determined whether the certificate for location information sharing is issued or not in accordance with the subscription information received from the mobile communication system 200 and the certificate for location information sharing is transmitted to the first wireless terminal 310; and a certificate management process wherein the certificate for location information sharing is copied and sent and the deletion of the copied and sent certificate and the set change of the validation period are conducted, through the connection of the first wireless terminal 310 to the authentication service system 100.

On the other hand, the location information sharing process includes the steps of: an authentication request process conducted in the mobile communication system 200 wherein the certificate for location information sharing is received and the received certificate for location information sharing is transmitted to the authentication service system 100 to request the authentication of the certificate for location information sharing; a certificate authentication process conducted in the authentication service system 100 wherein the issuance information on the certificate for location information sharing of which authentication is requested from the mobile communication system 200 is checked to determine whether the certificate for location information sharing is effective or not and the authentication information on the certificate for location information sharing is provided to the mobile communication system 200; and a location information sharing process conducted in the mobile communication system 200 wherein if the authentication information on the certificate for location information sharing is received from the authentication service system 100, the location information of the second wireless terminal 320 as the location information sharing object of the certificate is detected and the location information is produced from the detected location information, thereby transmitting the produced location information to the wireless terminal requesting the location information sharing.

Hereinafter, an operation of the system according to the present invention will be in detail explained.

The issuance of the certificate for location information sharing is previously obtained and saved in the first wireless terminal 310, and using the certificate, the location information sharing is requested.

In case of a minor (child), the parent requests the issuance of the certificate for location information sharing to the authentication service system 100 and saves the issued certificate in the first wireless terminal 310 (his or her mobile phone).

In this case, the requester of the issuance of the certificate for location information sharing and the location information sharing object (wireless terminal) are designated differently in the first wireless terminal 310 and the second wireless terminal 320.

The first wireless terminal 310 of the parent is connected to the authentication service system 100 to allow the certificate for location information sharing to be copied and sent to the third wireless terminal 330 as a guardian such as a teacher, babysitter and the like. At this time, the validation period of the certificate for location information sharing copied can be designated, and the copied certificate can be deleted.

In case of an adult, the certificate for location information sharing is copied and sent to the third wireless terminal 330 of a contact person with the adult, and the copied certificate is deleted and managed in the same manner.

So as to permit the police to use the location information, if the certificate for location information sharing is transmitted to the police from the first wireless terminal 310 where the certificate for location information sharing is saved and the third wireless terminal 330, the police transmits the certificate for location information sharing to the mobile communication system 200 to receive the location information from the mobile communication system 200.

At this time, if the authentication of the copied certificate for location information sharing is requested to the authentication service system 100 from the mobile communication system 200 excepting the first wireless terminal 310 as an original issuer, the authentication service system 100 notifies the first wireless terminal 310 of the request.

In case of general copying, the validity period is set, and in case of sending, it is effective before the deletion through the first wireless terminal 310.

Under the above operating characteristics, an explanation on the operating procedure of the system according to the present invention will be given.

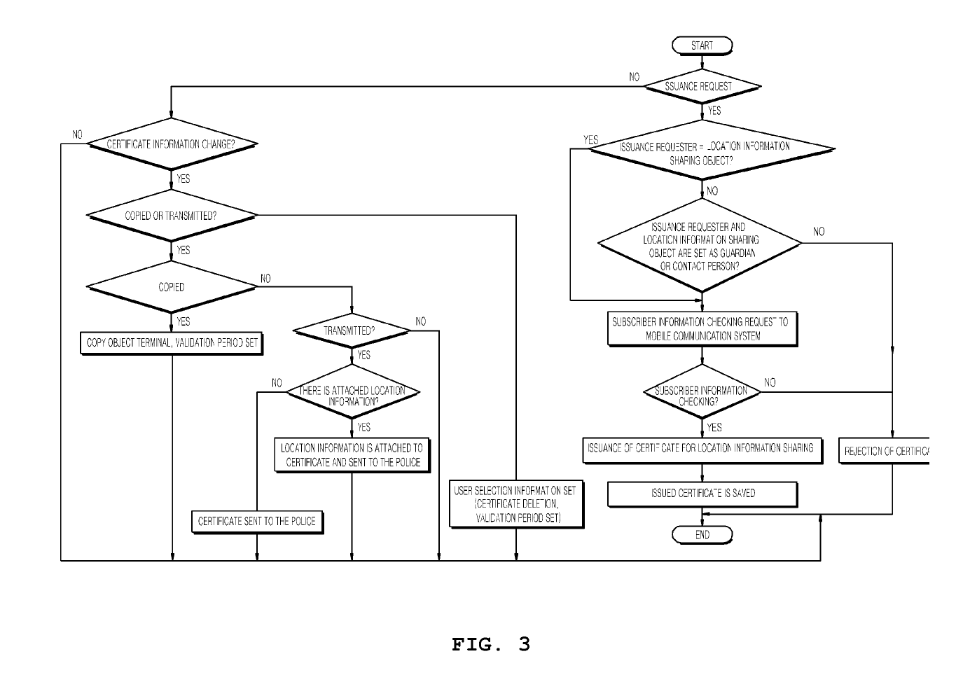

FIG. 3 is a flow chart showing a certification issuing procedure conducted in the authentication service system in the system according to the present invention.

So as to obtain the issuance of the certificate for location information sharing, first, the first wireless terminal 310 is connected to the authentication service system 100 to request the issuance of the certificate for location information sharing.

If the request of the issuance of the certificate for location information sharing is checked in the authentication service system 100, the authentication service system 100 requests the subscriber information on the first wireless terminal 310 requesting the issuance of the certificate to the mobile communication system 200.

At this time, if the requester of the issuance of the certificate for location information sharing and the location information sharing object are different from the first wireless terminal 310 and the second wireless terminal 320, the set membership information is checked to check whether the requester of the issuance of the certificate is set as the designated person (guardian or contact person) of the location information sharing object.

That is, it is checked whether upon the registration of the membership on the authentication service system 100, the requester of the issuance of the certificate is set as the designated person, or in case of a minor, the relationship between the parent and child is proved.

If it is checked that the requester of the issuance of the certificate is not set as the designated person, the issuance of the certificate for location information sharing is rejected, and if it is checked that the issuance requester of the first wireless terminal 310 is set as the designated person of the second wireless terminal 320, the subscriber information checking is requested to the mobile communication system 200.

If the checking result from the mobile communication system 200 is transmitted to the authentication service system 100, the authentication service system 100 checks the checked result to issue the certificate for location information sharing to the first wireless terminal 310 as the issuance requester.

The issued certificate for location information sharing and the issuance detail information are saved in the database 120 of the authentication service system 100.

Next, the certificate for location information sharing is received from the authentication service system 100 to the first wireless terminal 310 as the issuance requester and saved in the certificate saving unit 313.

The issued and saved certificate for location information sharing is copied and sent selectively to the third wireless terminal 330 as a guardian and to the fourth wireless terminal 340 as an aid organization (the police), and to do this, the first wireless terminal 310 is connected to the authentication service system 100 to request the certificate information change (copying, sending, and deleting).

If the first wireless terminal 310 selects copying, the information on the object to be copied (wireless terminal information) and the validation period information are requested from the authentication service system 100, and if the request is performed in the first wireless terminal 310, the copy of the certificate for location information sharing is conducted and transmitted from the authentication service system 100 to the third wireless terminal 330 of the corresponding copier.

The copy of the certificate for location information sharing is then received and saved in the third wireless terminal 330 of the corresponding copier, thereby completing the copying procedure.

In the same manner as the copying procedure, the sending procedure to the aid organization (the police) is conducted by requesting the sending to the authentication service system 100 from the first wireless terminal 310 where the certificate for location information sharing is saved or the third wireless terminal 330 and by sending the certificate for location information sharing to the fourth wireless terminal 340 of the police.

According to the present invention, the location information sharing is requested from the first wireless terminal 310 or the third wireless terminal 330 to the mobile communication system 200, and the certificate for location information sharing, together with the location information provided in the mobile communication system 200, is transmitted to the first wireless terminal 310 or the third wireless terminal 330.

Accordingly, the police utilizes the location information attached to the certificate for location information sharing to primarily check the location of the second wireless terminal 320.

The certificate for location information sharing provided to the fourth wireless terminal 340 of the police through the sending is effective before it is deleted in the authentication service system 100 through the original issuer.

The original issuer checks the current copying and sending detail information through the connection to the authentication service system 100 and deletes the copying or sending not desired further.

On the other hand, the location information sharing request and the location information sharing are carried out by the following procedure.

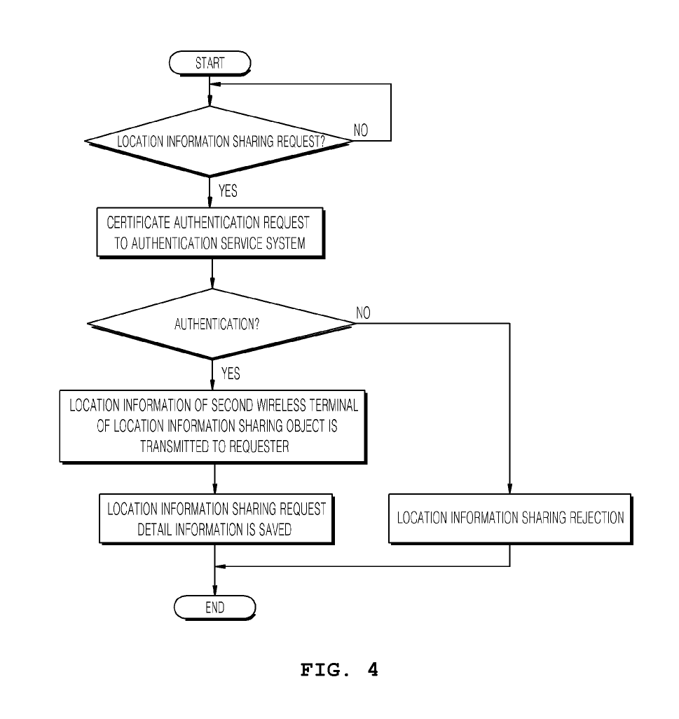

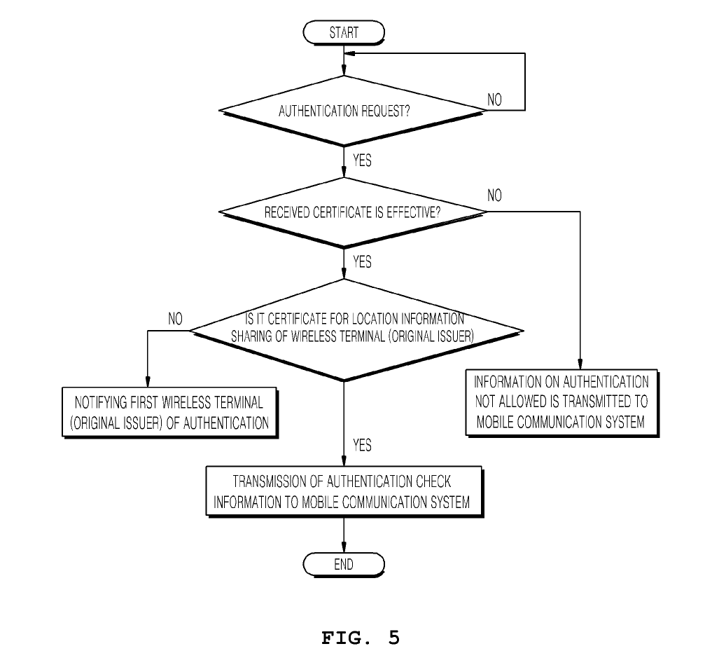

FIG. 4 is a flow chart showing the position information sharing procedure conducted in the mobile communication system, and FIG. 5 is a flow chart showing an authentication procedure of the certificate for the location information sharing conducted in the authentication service system in the system according to the present invention.

If the location information sharing is requested to the mobile communication system 200 from the first wireless terminal 310, the third wireless terminal 330 or the fourth wireless terminal 340 wherein the certificate for the location information sharing or the copy thereof is saved, the authentication of the certificate for the location information sharing attached upon the location information sharing is requested from the mobile communication system 200 to the authentication service system 100.

Next, the authentication service system 100 compares the certificate for the location information sharing of which authentication is requested from the mobile communication system 200 with the issuance detail information of the certificate for the location information sharing registered in the database 120 and checks whether it is effective. After that, the checked result is transmitted to the mobile communication system 200.

At this time, if it is checked that the certificate for the location information sharing of which authentication is requested from the mobile communication system 200 is not the certificate issued to the first wireless terminal 310 as the original issuer, but is copied or sent, the authentication service system 100 notifies the first wireless terminal 310 of the request of the authentication.

That is, the authentication service system 100 notifies the first wireless terminal 310 of the request of the location information sharing from the third wireless terminal 330 or the fourth wireless terminal 340.

After that, if the authentication of the certificate is completed in the authentication service system 100, the mobile communication system 200 detects the location information of the second wireless terminal 320 of which location information sharing is requested and produces the detected location information as the location information to be provided to send the produced location information to the wireless terminal requesting the location information sharing.

At this time, the mobile communication system 200 provides the location information using GIS information in such a manner as to check the location with easiness.

On the other hand, after the location information is sent to the first wireless terminal 310 or the third wireless terminal 330 from the mobile communication system 300, in case where the location of the second wireless terminal 320 is deviated from its original position and moved to a dangerous location, if the first wireless terminal 310 or the third wireless terminal 330 wants to notify the police of the situation, the certificate for the location information sharing is sent to the authentication service system 100, together with the attached location information provided from the mobile communication system 200.

Next, the certificate for the location information sharing with the attached location information is sent from the authentication service system 100 to the fourth wireless terminal 340.

The police first checks the attached location information and continuously requests the location information of the second wireless terminal 320 to the mobile communication system 200 so as to rapidly cope with this situation.

On the other hand, an explanation on another example of the sending of the certificate for the location information sharing will be given.

In the above-mentioned embodiment, in case where the location information as additional information is sent attached to the certificate for the location information sharing, the location information is provided to the aid organization (the police) when the authentication of the authentication service system 100 under the request of the mobile communication system 200 is obtained.

In another embodiment, in a case of a process (a), the wireless terminal where the certificate for the location information sharing is saved and the location information is received from the mobile communication system 200 thereto is connected to the authentication service system 100 and sends the certificate for the location information sharing to which the location information received from the mobile communication system 200 is attached to the fourth wireless terminal 340 of the aid organization (the police).

Alternatively, in a case of a process (b), only the location information received from the mobile communication system 200 is sent to the fourth wireless terminal 340 of the aid organization (the police).

In the case of the process (a), the authentication service system 100 further includes means for sending the certificate for the location information sharing to which the location information received from the mobile communication system 200 is attached to the aid organization (the police) if the certification sending is requested from the wireless terminal where the certificate for the location information sharing is saved to the authentication service system 100.

In the case of the process (b), the wireless terminal where the certificate for the location information sharing is saved further includes means for sending the location information received upon the location information sharing request from the mobile communication system 200 to the fourth wireless terminal 340 of the aid organization (the police).

So as to provide the location information from the mobile communication system 200 through the check of the information received upon the location information sharing request, if the location information is attached like the process (a) or if the location information is received like the process (b), the mobile communication system 200 checks the location information request details of the database 230 and provides the location information without any authentication process from the authentication service system 100.

In this case, until the location information providing stop is requested from the first wireless terminal 310, the mobile communication system 200 provides the certificate for the location information sharing to which the location information received from the mobile communication system 200 is attached or the location information received upon the location information sharing request.

Accordingly, the first wireless terminal 310 should request the mobile communication system 200 to stop the location information sharing request using the corresponding information (the certificate to which the location information is attached, or the location information).

The location information sharing request stop is requested directly to the mobile communication system 200 from the first wireless terminal 310 or to the authentication service system 100 from which the stop request is sent to the mobile communication system 200, and the stop request information is saved in the database 230 as the location information sharing request detail information.

Accordingly, the mobile communication system 200 checks the location information sharing request detail information of the database 230 to determine whether the authentication information (location information) to be sent to the fourth wireless terminal upon the location information sharing request is effective or not, and sends the location information in accordance with the checked result.

The location information of the location information sharing object can be rapidly provided together with the certificate for the location information sharing, thereby preventing the location information sharing from being erroneously and improperly used and achieving quick handling.

As described above, the authentication and management service system for providing location information according to the present invention can receive the location information of the location information sharing object together with the certificate for the location information sharing and selectively manage (copy, send and delete) the certificate through the user, thereby preventing the location information sharing from being erroneously and improperly used and achieving quick handling.

Especially, the parent previously obtains the issuance of the certificate for the location information sharing for the child's wireless terminal and saves the certificate in his or her wireless terminal, and in this state, he or she can request the location information sharing rapidly and if necessary, copies and sends the certificate to a guardian like a teacher or babysitter, thereby achieving quick handling in a dangerous situation.

At the time point when the location information is provided to the parent or the guardian, the location information provided upon emergency is attached to the certificate or the location information as the authentication information is sent directly to the police, so that the rapid handling is conducted through the police and the crime to occur the child can be beforehand prevented.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An authentication and management service system for providing location information, the system comprising:
an authentication service system for issuing a certificate for location information sharing of a location information sharing object to a designated person of the location information sharing object and for checking the information of the certificate issued and managed in response to the request of the authentication of the certificate for location information sharing from a mobile communication system to authenticate the location information sharing of the mobile communication system;
the mobile communication system for providing a location information service in accordance with the authentication results of the authentication service system of the certificate for location information sharing received upon request of the location information sharing from a wireless terminal where the certificate for location information sharing is saved;
a first wireless terminal for requesting the issuance of the certificate for location information sharing of the location information sharing object to the authentication service system, and saving and managing the issued certificate, and registered in the authentication service system as the certificate issuance designated person to request the location information sharing in communication with the mobile communication system; and
a second wireless terminal as the location information sharing object.

2. The authentication and management service system according to claim 1, wherein the authentication service system further comprises means for sending the certificate for the location information sharing to which the location information received from the mobile communication system is attached to an aid organization (the police) if the certification sending is requested from the wireless terminal where the certificate for the location information sharing is saved to the authentication service system.

3. The authentication and management service system according to claim 2, wherein the authentication service system further comprises authentication information notifying means for determining whether the certificate for location information sharing of which authentication is requested from the mobile communication system is the certificate for location information sharing originally issued or copied or sent, and if it is determined that the certificate is the certificate for location information sharing copied or sent, for transmitting the authentication detail information to the first wireless terminal as the original issuer of the certificate for location information sharing.

4. The authentication and management service system according to claim 2, wherein the authentication service system further comprises means for attaching the location information provided from the mobile communication system and received from the wireless terminal together with the certificate sensing request to the certificate for location information sharing, if the certificate sending is requested from the wireless terminal where the certificate for location information sharing is saved, and for sending the location information attached to the certificate for location information sharing to set aid organization (the police).

5. The authentication and management service system according to claim 2, wherein the first wireless terminal and the second wireless terminal further comprise means for transmitting the location information as authentication information received from the mobile communication system upon the request of the location information sharing to a fourth wireless terminal of the aid organization (the police), and the mobile communication system checks the location information sharing request details and if location information sharing stop is not requested from the original issuer, determines that the location information received upon the location information sharing request from the fourth wireless terminal is effective authentication information, thereby providing the location information.

6. The authentication and management service system according to claim 1, wherein the authentication service system comprises:
a certificate management server comprising a certificate issuance and management unit for checking subscriber information through the mobile communication system in response to the request of the issuance for the certificate for location information sharing from the first wireless terminal as the designated person, issuing the certificate for location information sharing using the checked subscriber information, and managing the issued certificate for location information sharing, and a certificate authentication control unit for comparing the certificate for location information sharing of which authentication is requested from the mobile communication system with the issued certificate for location information sharing saved and managed in the database to provide the authentication check result to the mobile communication system; and
a database for saving and managing the issuance detail information of the certificate for location information sharing, the information of the issued certificate for location information sharing, authentication detail information and set membership information.

7. An authentication and management service system for providing location information, the system comprising:
a mobile communication system comprising a location information sharing authentication server for issuing a certificate for location information sharing of a location information sharing object to a designated person registered in the subscriber information of the location information sharing object and for checking the certificate information issued and managed for the certificate for location information sharing received upon request of the location information sharing to determine the location information sharing of the location information sharing object; a first wireless terminal for requesting the issuance of the certificate for location information sharing of the location information sharing object to the mobile communication system, and saving and managing the issued certificate, and registered in the subscriber information in the mobile communication system as the certificate issuance designated person to request the location information sharing in communication with the mobile communication system; and a second wireless terminal as the location information sharing object.

8. The authentication and management service system according to claim 7, wherein the location information sharing authentication server of the mobile communication system further comprises means for providing a management process of the certificate for location information sharing in which the certificate for location information sharing is copied and sent to a third wireless terminal of another person (guardian or contact person) designated from the first wireless terminal of the designated person to which the certificate for location information sharing is issued or sent to a fourth wireless terminal of an aid organization (the police).

9. The authentication and management service system according to claim 8, wherein the location information sharing authentication server of the mobile communication system further comprises location information notifying means for determining whether the certificate for location information sharing of which authentication is requested is the certificate for location information sharing originally issued or copied or sent, and if it is determined that the certificate for location information sharing is the certificate for location information sharing copied or sent, for transmitting the certificate location information sharing request detail information to the first wireless terminal as the original issuer of the certificate for location information sharing.

10. The authentication and management service system according to claim 1, wherein the mobile communication system comprises:
a location information detection server for detecting the location of the second wireless terminal of which location information sharing is requested and producing the location information to be provided to the wireless terminal requesting the location information sharing, using the detected location;
a location information providing server for requesting the authentication service system to authenticate the certificate for location information sharing transmitted upon the request of the location information sharing from the wireless terminal and providing the location information produced from the location information detection server in accordance with the authentication result to the wireless terminal requesting the location information sharing; and
a database for saving and managing the mobile communication subscriber information, the location information request detail information, and the provided location information.

11. The authentication and management service system according to claim 6, wherein the information saved and managed in the database includes the issuance detail information of the certificate for location information sharing, the information of the certificate for location information sharing and the authentication detail information of the certificate for location information sharing, the issuance detail information of the certificate for location information sharing including the history information of the certificate issued until now, the information of the certificate for location information sharing including basic information of the certificate and additional information on the copy and transmission of the certificate, and the authentication detail information of the certificate for location information sharing including the detail information of which authentication is requested from the mobile communication system.

12. The authentication and management service system according to claim 11, wherein the base information includes inherent identification information, certificate issuer, validation period, issuer, and the information on the wireless terminal of the location information sharing object, and the additional information includes the certificate attribute information indicating whether copy is possible and validation period designation information.

13. The authentication and management service system according to claim 1, wherein the mobile communication system further comprises a GIS information database, and in producing the location information of the wireless terminal of which location information sharing is requested, further comprises location information providing means for converting the detected location information into GIS information to produce and provide the location information.

14. The authentication and management service system according to claim 8, wherein the location information request detail information saved and managed in the database of the mobile communication system includes a location information sharing requester and the information (telephone numbers or subscriber name) of the wireless terminal of which location information is shared.

15. A method for issuing and managing a certificate for location information sharing, the method comprising the steps of:
a certificate object information checking process wherein if the issuance of a certificate for location information sharing is requested from a wireless terminal, the issuance request information inputted from the wireless terminal is transmitted to a mobile communication system to request the subscriber checking;
a certificate issuance process wherein the subscription checking information on the subscriber information from the mobile communication system is received, and if the subscriber is a normal subscriber, the issuance of the certificate is determined to transmit the certificate for location information sharing to the wireless terminal requesting the issuance of the certificate for location information sharing; and
a certificate management process wherein the certificate for location information sharing is copied and sent to a third wireless terminal of a designated person (guardian or contact person) and transmitted to a fourth wireless terminal of an aid organization (the police) in accordance with the management information inputted upon the request of the wireless terminal where the certificate for location information sharing is saved, and the deletion of the copied and sent certificate and the set change of the validation period are conducted.

16. The method according to claim 15, wherein the certificate object information checking process comprises the steps of: determining whether the certificate issuance object is the same as the wireless terminal of the location information sharing object through the check of the issuance request information inputted from the wireless terminal;
if the certificate issuance object is different from the wireless terminal of the location information sharing object, checking set membership information to determine whether the certificate issuance object and the wireless terminal of the location information sharing object are registered as designated persons;
if registered as the designated persons, transmitting the issuance request information to the mobile communication system to request the subscriber checking; and
if not registered as the designated persons, rejecting the issuance of the certificate for location information sharing.

17. The method according to claim 15, wherein in the certificate management process, if the certificate sending is requested from the wireless terminal where the certificate for location information sharing is saved, the location information provided from the mobile communication system, which is received from the wireless terminal together with the certificate sensing request, is attached to the certificate for location information sharing and sent to the aid organization (the police).

18. The method according to claim 15, wherein in the certificate issuance and management processes, the issuance detail information of the certificate for location information sharing, the information of the certificate for location information sharing and the authentication detail information of the certificate for location information sharing are saved, the issuance detail information of the certificate for location information sharing including the history information of the certificate issued until now, the information of the certificate for location information sharing including basic information of the certificate and additional information on the copy and transmission of the certificate, and the authentication detail information of the certificate for location information sharing including the detail information of which authentication is requested from the mobile communication system.

19. The method according to claim 18, wherein the base information includes inherent identification information, certificate issuer, validation period, an issuer, and the information on the wireless terminal of the location information sharing object, and the additional information includes the certificate attribute information indicating whether copy is possible and validation period designation information.

20. An authentication and management service method for providing location information, the method comprising the steps of:
an authentication request process conducted in a mobile communication system wherein a certificate for location information sharing is received and the received certificate for location information sharing is transmitted to an authentication service system to request the authentication of the certificate for location information sharing;
a certificate authentication process conducted in the authentication service system wherein the issuance information on the certificate for location information sharing of which authentication is requested from the mobile communication system is checked to determine whether the certificate for location information sharing is effective or not and the authentication information on the certificate for location information sharing is provided to the mobile communication system; and
a location information providing process conducted in the mobile communication system wherein if the authentication information for the certificate for location information sharing is received from the authentication service system, the location information of a second wireless terminal as a location information sharing object of the certificate is detected and the location information is produced from the detected location information to transmit the produced location information to the wireless terminal requesting the location information sharing.

21. The method according to claim 20, wherein the certificate authentication process further comprises the steps of:
a certificate attribute determination process wherein the issuance information of the certificate for location information sharing of which authentication is requested from the mobile communication system is checked to determine whether the certificate is the certificate for location information sharing originally issued or the certificate for location information sharing copied or sent; and
a location information sharing notifying process wherein if it is determined that the certificate is the certificate for location information sharing originally issued, the authentication information is provided to the mobile communication system, and if it is determined that the certificate is the certificate for location information sharing copied or sent, the authentication information is provided to the mobile communication system, while notifying the first wireless terminal as the original issuer of the location information sharing request from the wireless terminals as the designated person of the certificate for location information sharing copied or sent.

22. The method according to claim 20, wherein in the authentication request process, if the location information provided from the mobile communication system is received as the authentication information received upon the request of the location information sharing, the location information sharing request details are checked to determine whether the location information sharing stop is requested from the original issuer, and if not requested, the location information is effective and thus provided.

23. The method according to claim 20, wherein the certificate authentication process further comprises the step of saving the authentication details of the certificate for location information sharing.

24. The method according to claim 20, wherein the location information providing process conducted in the mobile communication system further comprises the step of saving the location information provided.

25. The method according to claim 20, wherein the location information providing process further comprises the steps of detecting the location information of the second wireless terminal of the location information sharing object if the authentication of the certificate for location information sharing is completed, detecting the location of the wireless terminal of the location information sharing object, and converting the detected location information into GIS information to produce and provide the location information.
